(19) United States
(12) Patent Application Publication
(10) Pub. No.: US 2007/0005422 A1
(43) Pub. Date: Jan. 4, 2007

(54) Techniques for image generation

(75) Inventors: Royce A. Levien, Lexington, MA (US); Robert W. Lord, Seattle, WA (US); Mark A. Malamud, Seattle, WA (US); John D. Rinaldo JR., Bellevue, WA (US)

Correspondence Address: SEARETE LLC;CLARENCE T. TEGREENE, 1756 - 114TH AVE., S.E., SUITE 110, BELLEVUE, WA, 98004, US

(73) Assignee: Searete LLC, a limited liability corporation of the State of Delaware

(21) Appl. No.: 11/173,990

(22) Filed: Jul. 1, 2005

Related U.S. Application Data
(63) Continuation of application No. 11/174,432, filed on Jul. 1, 2005.

(51) Int. Cl. G07G 1/14

(52) U.S. Cl. 705/14

(57) ABSTRACT

An apparatus, methods and computer program product are provided that receive a venue-related image request from a user, receive image-related information associated with the venue and generate an image based at least in part on the image request and the image-related information.

### RELATED APPLICATIONS

1. For purposes of the USPTO extra-statutory requirements, the present application constitutes a continuation in part of currently co-pending United States patent application entitled PROVIDING PROMOTIONAL CONTENT, naming Royce A. Levien; Robert W. Lord; Mark A. Malamud and John D. Rinaldo, Jr., as inventors, USAN: To be Assigned, filed Jul. 1, 2005.

### CROSS-REFERENCE TO RELATED APPLICATIONS

The present application is related to, claims the earliest available effective filing date(s) from (e.g., claims earliest available priority dates for other than provisional patent applications; claims benefits under 35 USC § 119(e) for provisional patent applications), and incorporates by reference in its entirety all subject matter of the following listed application(s) (the “Related Applications”) to the extent such subject matter is not inconsistent herewith; the present application also claims the earliest available effective filing date(s) from, and also incorporates by reference in its entirety all subject matter of any and all parent, grandparent, great-grandparent, etc. applications of the Related Application(s) to the extent such subject matter is not inconsistent herewith. The United States Patent Office (USPTO) has published a notice to the effect that the USPTO's computer programs require that patent applicants reference both a serial number and indicate whether an application is a continuation or continuation in part. Stephen G. Kunin, Benefit of Prior-Filed Application, USPTO Electronic Official Gazette, Mar. 18, 2003 at http://www.uspto.gov/web/offices/com/sol/og/2003/week11/patbene.htm. The present applicant entity has provided below a specific reference to the application(s) from which priority is being claimed as recited by statute. Applicant entity understands that the statute is unambiguous in its specific reference language and does not require either a serial number or any characterization such as “continuation” or “continuation-in-part.” Notwithstanding the foregoing, applicant entity understands that the USPTO's computer programs have certain data entry requirements, and hence applicant entity is designating the present application as a continuation in part of its parent applications, but expressly points out that such designations are not to be construed in any way as any type of commentary and/or admission as to whether or not the present application contains any new matter in addition to the matter of its parent application(s).

### SUMMARY

An embodiment provides a method. In one implementation, the method includes receiving a venue-related image request from a user, receiving image-related information associated with the venue, and generating an image based at least in part on the image request and the image-related information. In addition to the foregoing, other method aspects are described in the claims, drawings, and text forming a part of the present disclosure.

An embodiment provides a computer program product. In one implementation, the computer program product includes but is not limited to a signal bearing medium bearing at least one of one or more instructions for receiving a venue-related image request from a user, one or more instructions for receiving image-related information associated with the venue, and one or more instructions for generating an image based at least in part on the image request and the image-related information. In addition to the foregoing, other computer program product aspects are described in the claims, drawings, and text forming a part of the present disclosure.

A further embodiment provides an apparatus. In one implementation, the apparatus includes a computing device and instructions that when executed on the computing device cause the computing device to receive a venue-related image request from a user, receive image-related information associated with the venue, and provide the requested image to the user, the requested image generated based at least in part on the image request and the image-related information. In addition to the foregoing, other apparatus aspects are described in the claims, drawings, and text forming a part of the present disclosure.

Another embodiment provides a method. In one implementation, the method includes sending a venue-related image request, and receiving the requested image, the requested image generated based at least in part on the venue-related image request and image-related information associated with the venue. In addition to the foregoing, other method aspects are described in the claims, drawings, and text forming a part of the present disclosure.

Another embodiment provides an apparatus. In one implementation, the apparatus includes a computing device, and instructions that when executed on the computing device cause the computing device to send a venue-related image request and receive the requested image, the requested image generated based at least in part on the venue-related image request and image-related information associated with the venue. In addition to the foregoing, other apparatus aspects are described in the claims, drawings, and text forming a part of the present disclosure.

In addition to the foregoing, various other embodiments are set forth and described in the text (e.g., claims and/or detailed description) and/or drawings of the present disclosure.

The foregoing is a summary and thus contains, by necessity, simplifications, generalizations and omissions of detail; consequently, those skilled in the art will appreciate that the summary is illustrative only and is not intended to be in any way limiting. Other aspects, inventive features, and advantages of the devices and/or processes described herein, as defined solely by the claims, will become apparent in the detailed description set forth herein.

### BRIEF DESCRIPTION OF THE DRAWINGS

FIG. 1 illustrates an example system in which embodiments may be implemented, including a general-purpose computing device.

FIG. 2 illustrates an operational flow representing example operations that generate an image.

FIG. 3 illustrates an alternative embodiment of the example operational flow 200 of FIG. 2.

FIG. 4 illustrates an alternative embodiment of the example operational flow 200 of FIG. 2.

FIG. 5 illustrates an alternative embodiment of the receiving operation 410 illustrated in FIG. 4.

FIG. 6 illustrates an alternative embodiment of the example operational flow 200 of FIG. 2.

FIG. 7 illustrates an alternative embodiment of the example operational flow 200 of FIG. 2.

FIG. 8 illustrates an alternative embodiment of the example operational flow 200 of FIG. 2.

FIG. 9 illustrates an alternative embodiment of the example operational flow 200 of FIG. 2.

FIG. 10 illustrates an alternative embodiment of the example operational flow 200 of FIG. 2.

FIG. 11 illustrates an alternative embodiment of the example operational flow 200 of FIG. 2.

FIG. 12 illustrates an alternative embodiment of the example operational flow 200 of FIG. 2.

FIG. 13 illustrates a partial view of an example computer program product.

FIG. 14 illustrates an example apparatus in which embodiments may be implemented.

FIG. 15 illustrates an operational flow 1500 representing example operations to receive a requested image.

FIG. 16 illustrates an alternative embodiment of the example operational flow 1500 of FIG. 15.

FIG. 17 illustrates an alternative embodiment of the example operational flow 1500 of FIG. 15.

FIG. 18 illustrates an example apparatus 1800 in which embodiments may be implemented.

FIG. 19 is an example environment 1900 in which various embodiments may be used or implemented.

FIG. 20 is an example environment 2000 in which various embodiments may be used or implemented.

The use of the same symbols in different drawings typically indicates similar or identical items.

### DETAILED DESCRIPTION

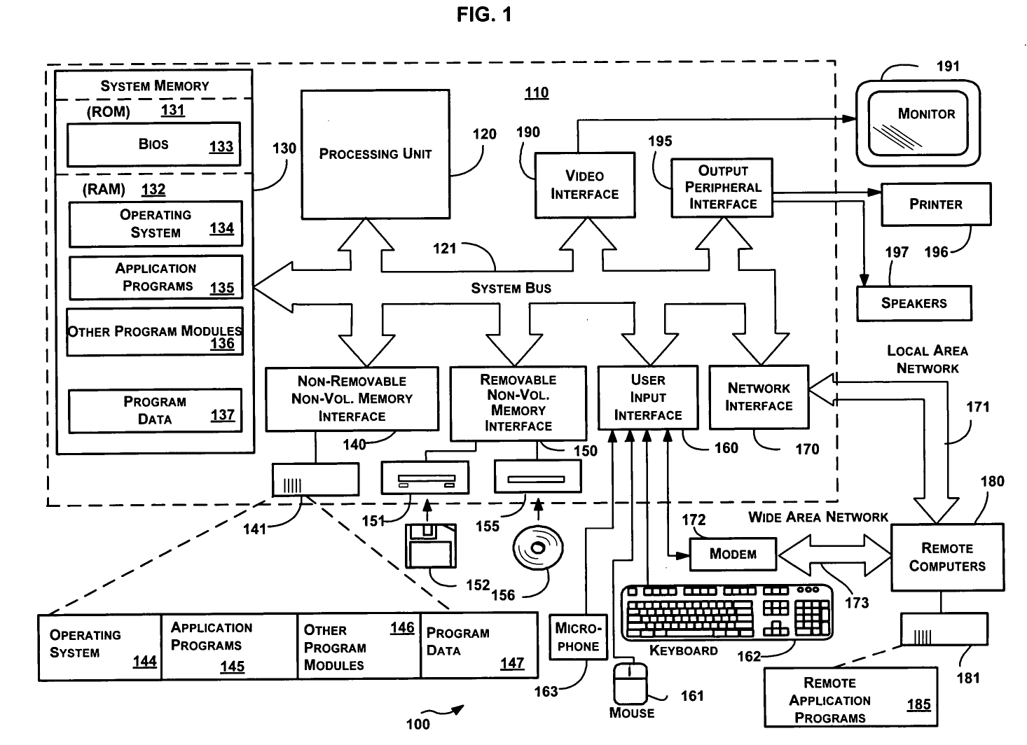

FIG. 1 and the following discussion are intended to provide a brief, general description of an environment in which embodiments may be implemented. FIG. 1 illustrates an example electronic device that may correspond in whole or part to a general-purpose computing device, and is shown as a computing system environment 100. Components of the computing system environment 100 may include, but are not limited to, a computing device 110 having a processing unit 120, a system memory 130, and a system bus 121 that couples various system components including the system memory 130 to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, also known as Mezzanine bus.

The computing system environment 100 typically includes a variety of computer-readable media products. Computer-readable media may include any media that can be accessed by the computing device 110 and include both volatile and nonvolatile media, removable and non-removable media. By way of example, and not of limitation, computer-readable media may include computer storage media and communications media.

Computer storage media includes both volatile and nonvolatile, removable and non-removable media implemented in any method or technology for storage of information such as computer-readable instructions, data structures, program modules, or other data. Computer storage media include, but are not limited to, random-access memory (RAM), read-only memory (ROM), electrically erasable programmable read-only memory (EEPROM), flash memory, or other memory technology, CD-ROM, digital versatile disks (DVD), or other optical disk storage, magnetic cassettes, magnetic tape, magnetic disk storage, or other magnetic storage devices, or any other medium which can be used to store the desired information and which can be accessed by the computing device 110.

Communications media typically embody computer-readable instructions, data structures, program modules, or other data in a modulated data signal such as a carrier wave or other transport mechanism and include any information delivery media. The term “modulated data signal” means a signal that has one or more of its characteristics set or changed in such a manner as to encode information in the signal. By way of example, and not limitation, communications media include wired media such as a wired network and a direct-wired connection and wireless media such as acoustic, RF, optical, and infrared media. Combinations of any of the above should also be included within the scope of computer-readable media.

The system memory 130 includes computer storage media in the form of volatile and nonvolatile memory such as ROM 131 and RAM 132. A basic input/output system (BIOS) 133, containing the basic routines that help to transfer information between elements within the computing device 110, such as during start-up, is typically stored in ROM 131. RAM 132 typically contains data and program modules that are immediately accessible to or presently being operated on by processing unit 120. By way of example, and not limitation, FIG. 1 illustrates an operating system 134, application programs 135, other program modules 136, and program data 137. Often, the operating system 134 offers services to applications programs 135 by way of one or more application programming interfaces (APIs) (not shown). Because the operating system 134 incorporates these services, developers of applications programs 135 need not redevelop code to use the services. Examples of APIs provided by operating systems such as Microsoft's “WINDOWS” are well known in the art.

The computing device 110 may also include other removable/non-removable, volatile/nonvolatile computer storage media products. By way of example only, FIG. 1 illustrates a non-removable non-volatile memory interface (hard disk interface) 140 that reads from and writes to non-removable, non-volatile magnetic media, a magnetic disk drive 151 that reads from and writes to a removable, non-volatile magnetic disk 152, and an optical disk drive 155 that reads from and writes to a removable, non-volatile optical disk 156 such as a CD ROM. Other removable/nonremovable, volatile/non-volatile computer storage media that can be used in the example operating environment include, but are not limited to, magnetic tape cassettes, flash memory cards, DVDs, digital video tape, solid state RAM, and solid state ROM. The hard disk drive 141 is typically connected to the system bus 121 through a memory interface, such as the interface 140, and magnetic disk drive 151 and optical disk drive 155 are typically connected to the system bus 121 by a removable non-volatile memory interface, such as interface 150.

The drives and their associated computer storage media discussed above and illustrated in FIG. 1 provide storage of computer-readable instructions, data structures, program modules, and other data for the computing device 110. In FIG. 1, for example, hard disk drive 141 is illustrated as storing an operating system 144, application programs 145, other program modules 146, and program data 147. Note that these components can either be the same as or different from the operating system 134, application programs 135, other program modules 136, and program data 137. The operating system 144, application programs 145, other program modules 146, and program data 147 are given different numbers here to illustrate that, at a minimum, they are different copies. A user may enter commands and information into the computing device 110 through input devices such as a microphone 163, keyboard 162, and pointing device 161, commonly referred to as a mouse, trackball, or touch pad. Other input devices (not shown) may include a joystick, game pad, satellite dish, and scanner. These and other input devices are often connected to the processing unit 120 through a user input interface 160 that is coupled to the system bus, but may be connected by other interface and bus structures, such as a parallel port, game port, or a universal serial bus (USB). A monitor 191 or other type of display device is also connected to the system bus 121 via an interface, such as a video interface 190. In addition to the monitor 191, computers may also include other peripheral output devices such as speakers 197 and printer 196, which may be connected through an output peripheral interface 195.

The computing system environment 100 may operate in a networked environment using logical connections to one or more remote computers, such as a remote computer 180. The remote computer 180 may be a personal computer, a server, a router, a network PC, a peer device, or other common network node, and typically includes many or all of the elements described above relative to the computing device 110, although only a memory storage device 181 has been illustrated in FIG. 1. The logical connections depicted in FIG. 1 include a local area network (LAN) 171 and a wide area network (WAN) 173, but may also include other networks such as a personal area network (PAN) (not shown). Such networking environments are commonplace in offices, enterprise-wide computer networks, intranets, and the Internet.

When used in a LAN networking environment, the computing system environment 100 is connected to the LAN 171 through a network interface or adapter 170. When used in a WAN networking environment, the computing device 110 typically includes a modem 172 or other means for establishing communications over the WAN 173, such as the Internet. The modem 172, which may be internal or external, may be connected to the system bus 121 via the user input interface 160, or via another appropriate mechanism. In a networked environment, program modules depicted relative to the computing device 110, or portions thereof, may be stored in a remote memory storage device. By way of example, and not limitation, FIG. 1 illustrates remote application programs 185 as residing on memory device 181. It will be appreciated that the network connections shown are examples and other means of establishing a communications link between the computers may be used.

In the description that follows, certain embodiments may be described with reference to acts and symbolic representations of operations that are performed by one or more computing devices, such as computing device 10 of FIG. 1. As such, it will be understood that such acts and operations, which are at times referred to as being computer-executed, include the manipulation by the processing unit of the computer of electrical signals representing data in a structured form. This manipulation transforms the data or maintains them at locations in the memory system of the computer, which reconfigures or otherwise alters the operation of the computer in a manner well understood by those skilled in the art. The data structures where data are maintained are physical locations of the memory that have particular properties defined by the format of the data. However, while an embodiment is being described in the foregoing context, it is not meant to be limiting as those of skill in the art will appreciate that the acts and operations described hereinafter may also be implemented in hardware.

Thus, FIG. 1 illustrates an example of a suitable environment on which embodiments may be implemented. The computing system environment 100 of FIG. 1 is an example of a suitable environment and is not intended to suggest any limitation as to the scope of use or functionality of an embodiment. Neither should the environment be interpreted as having any dependency or requirement relating to any one or combination of components illustrated in an example operating environment.

Embodiments may be implemented with numerous other general-purpose or special-purpose computing devices and computing system environments or configurations. Examples of well-known computing systems, environments, and configurations that may be suitable for use with an embodiment include, but are not limited to, personal computers, server computers, hand-held or laptop devices, personal digital assistants, cell phones, wireless communications devices, wireless communications devices that may include an image capture device, multiprocessor systems, microprocessor-based systems, set top boxes, programmable consumer electronics, network, minicomputers, mainframe computers, and distributed computing environments that include any of the above systems or devices.

Embodiments may be described in a general context of computer-executable instructions, such as program modules, being executed by a computer. Generally, program modules include routines, programs, objects, components, data structures, etc., that perform particular tasks or implement particular abstract data types. An embodiment may also be practiced in distributed computing environments where tasks are performed by remote processing devices that are linked through a communications network. In a distributed computing environment, program modules may be located in both local and remote computer storage media including memory storage devices.

The following include a series of illustrations depicting implementations of processes. For ease of understanding, certain illustrations are organized such that the initial illustrations present implementations via an overall “big picture” viewpoint and thereafter the following illustrations present alternate implementations and/or expansions of the “big picture” illustrations as either sub-steps or additional steps building on one or more earlier-presented illustrations. This style of presentation utilized herein (e.g., beginning with a presentation of a illustration(s) presenting an overall view and thereafter providing additions to and/or further details in subsequent illustrations) generally allows for a rapid and easy understanding of the various process implementations. In addition, those skilled in the art will further appreciate that the style of presentation used herein also lends itself well to modular and/or object-oriented program design paradigms.

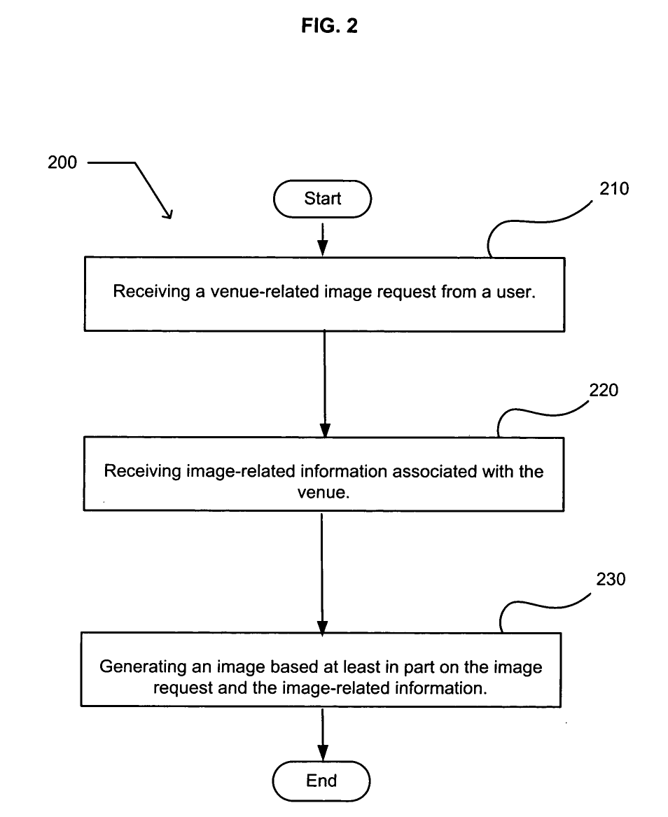

FIG. 2 illustrates an operational flow 200 representing example operations that generate an image. After a start operation, the operational flow 200 moves to a receiving operation 210 where a venue-related image request is received from a user. At receiving operation 220, image-related information associated with the venue is received. At generating operation 230, an image is generated based at least in part on the image request and the image-related information. The operational flow 200 then moves to an end operation.

A venue may include any location, geographic region, place or a group of locations, regions or places. The venue may, for example, be a public venue such as a National Park (such as the Grand Canyon), city or area within a city, a region of a state or country, a shopping mall (including a group or all stores within the mall), or a private venue such as a private residence or private property. Examples of venues may include an amusement park (such as Disney World), areas of gatherings such as a picnic area, a building, a room, places of performance or participation such as a concert hall, a stadium (such as a football or baseball stadium), a mountain ski resort, etc., although the invention is not limited thereto.

As noted above, a venue may include a group of locations, regions or places. For example, a venue may include a group of National parks, such as the National Parks within California, or all (or a subset of the) stores within a specific shopping mall, or all stadiums, or all places providing a performance of a specific type (e.g., all NFL football stadiums or all amusement parks in Pennsylvania), or a group of venues that provided an event or specific performance (or type of event or performance) over a specific time period (e.g., over the last 2 years), or a group of specific venues that may be listed or provided. These are merely a few illustrative examples and the invention is not limited thereto.

In an example embodiment, an image request may, for example, specify an image to be generated or specify various details or attributes of an image to be generated (requested image), or both. Thus, an image request may specify a person, place or thing, a time, venue or other information. A venue-related image request may be a request for an image that is related to a venue. In an example embodiment, a venue-related image request may include a request for an image captured at a specific venue, although the invention is not limited thereto.

In an example embodiment, a user may be a human user, such as a person or group of people. Those skilled in the art will appreciate that a user may also include an electronic user or robotic user, such as an electronic device or a user's device, or an electronic device in use by a person, although the invention is not limited thereto. A user may include a computing device, such as a cell phone, a PDA, a laptop computer, or other wireless device, as examples, although the invention is not limited thereto. Those skilled in the art will appreciate that, in general, the same may be said of “sender,” “receiver,” “transmitter,” and/or other entity-oriented terms as such terms are used herein.

As noted above, at generating operation 230, an image may be generated based at least in part on the image request and the image-related information. Image-related information may include a wide variety of information that is related to an image, such as attributes of an image or requested image, one or more images or portions of images, attributes or information that may be used to identify an image, sensor data that may provide data relating to light or light intensity and other conditions that may be related to or useful in the capturing, generating and processing of images, and the like. The generating operation 230 may be performed in a wide variety of manners, such as retrieving, capturing or obtaining an image that corresponds to the image-request, processing an image, combining multiple images or portions of images, etc. These are merely provided as examples, and the invention is not limited thereto.

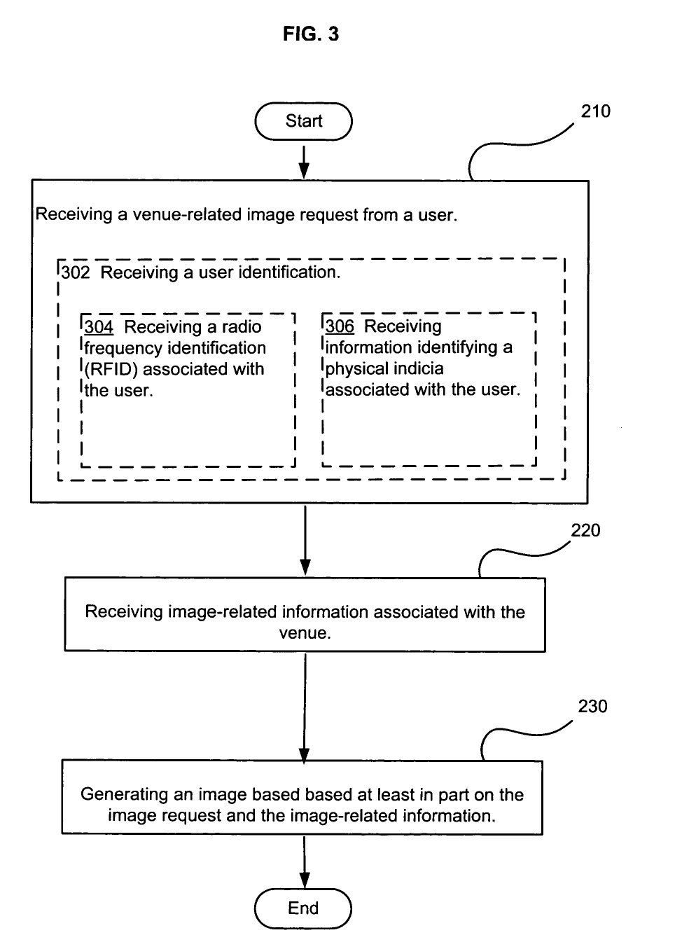

FIG. 3 illustrates an alternative embodiment of the example operational flow 200 of FIG. 2. FIG. 3 illustrates an embodiment where the receiving operation 210 may include at least one additional operation. Additional operations may include operations 302, 304 and 306. At operation 302, a user identification is received. At operation 304, a radio frequency identification (RFID) associated with the user is received. In an example embodiment, a user may include an RFID which may identify the user. In an example embodiment, a user may include an RFID transmitter to transmit the RFID signal to allow the user to be identified. At receiving operation 306, information is received identifying a physical indicia associated with the user. For example, information may be provided indicating that the user may wear a specific number (e.g., 133) to identify the user, or may wear a hat of a specific color, or a jacket of a specific type, or other physical indicia that may be associated with the user. In this manner, it may be possible to identify a user based upon this information.

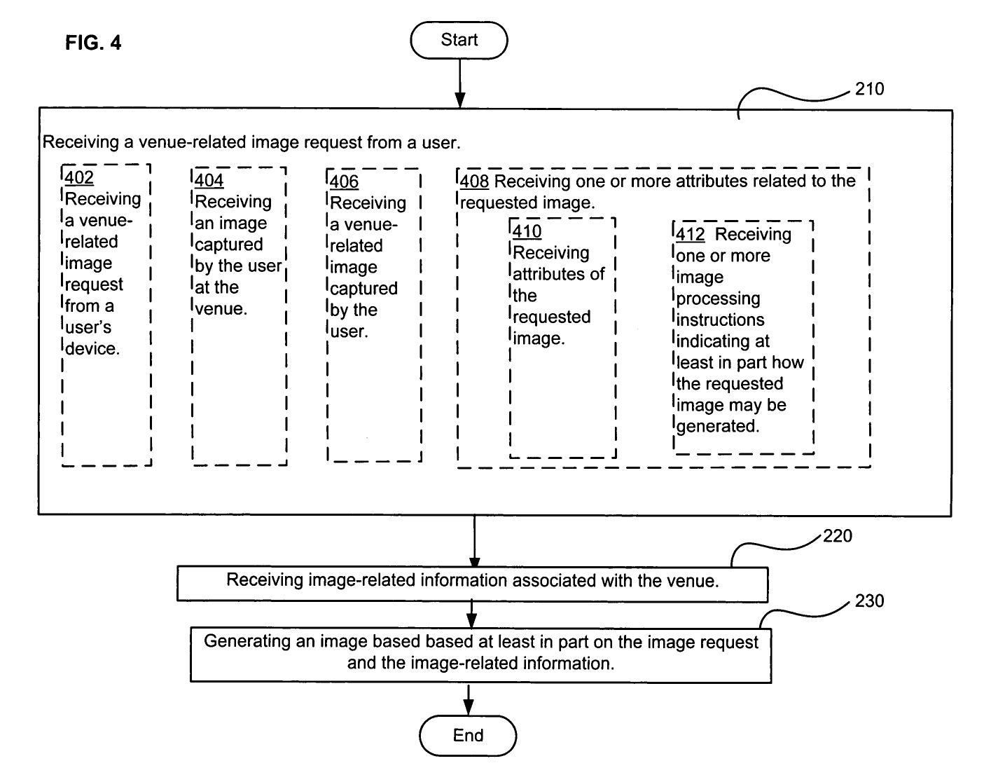

FIG. 4 illustrates an alternative embodiment of the example operational flow 200 of FIG. 2. FIG. 4 illustrates an embodiment where the receiving operation 210 may include at least one additional operation. Additional operations may include operations 402, 404, 406, 408, 410 and 412. At receiving operation 402, a venue-related image request is received from a user's device. At receiving operation 404, an image captured by the user at the venue is received. At receiving operation 406, a venue-related image captured by the user is received. At receiving operation 408, one or more attributes related to the requested image are received. At receiving operation 410, attributes of the requested image are received. At receiving operation 412, one or more image processing instructions indicating at least in part how the requested image may be generated is received.

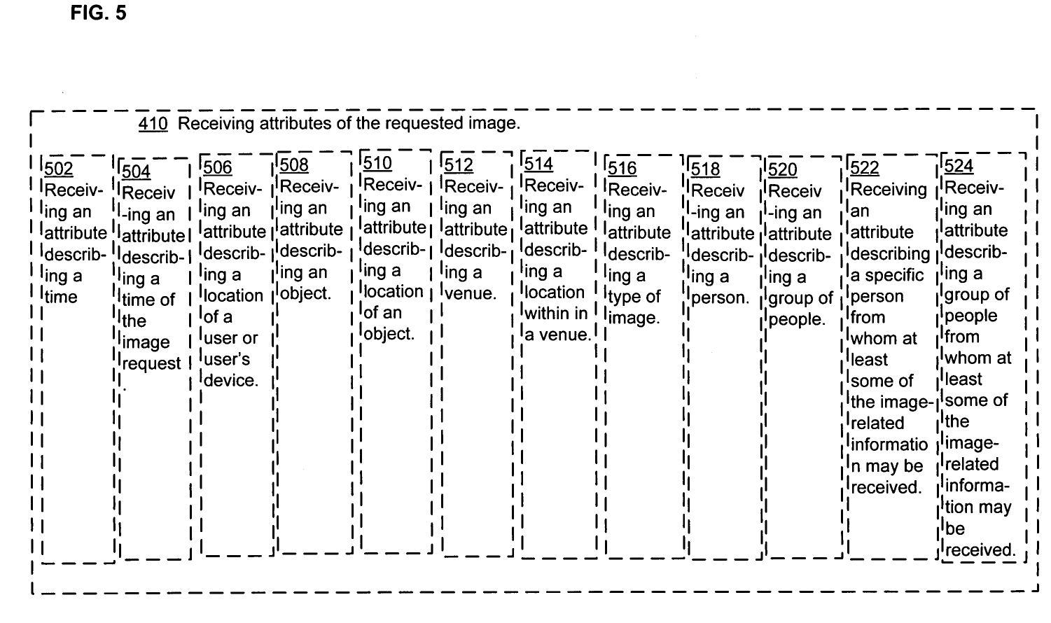

FIG. 5 illustrates an alternative embodiment of the receiving operation 410 illustrated in FIG. 4. FIG. 5 illustrates an embodiment where the receiving operation 410 may include at least one additional operation. Additional operations may include operations 502, 504, 506, 508, 510, 512, 514, 516, 518, 520, 522 and 524. At receiving operation 502, an attribute describing a time is received. At receiving operation 504, an attribute describing a time of the image request is received. At receiving operation 506, an attribute describing a location of a user or user's device is received. At receiving operation 508, an attribute describing an object is received. At receiving operation 510, an attribute describing a location of an object is received. At receiving operation 512, an attribute describing a venue is received. At receiving operation 514, an attribute describing a location within a venue is received. At receiving operation 516, an attribute describing a type of image is received. At receiving operation 518, an attribute describing a person is received. At receiving operation 520, an attribute describing a group of people is received. At receiving operation 522, an attribute describing a specific person from whom at least some of the image-related information may be received. At receiving operation 524, an attribute describing a group of people from whom at least some of the image-related information may be received.

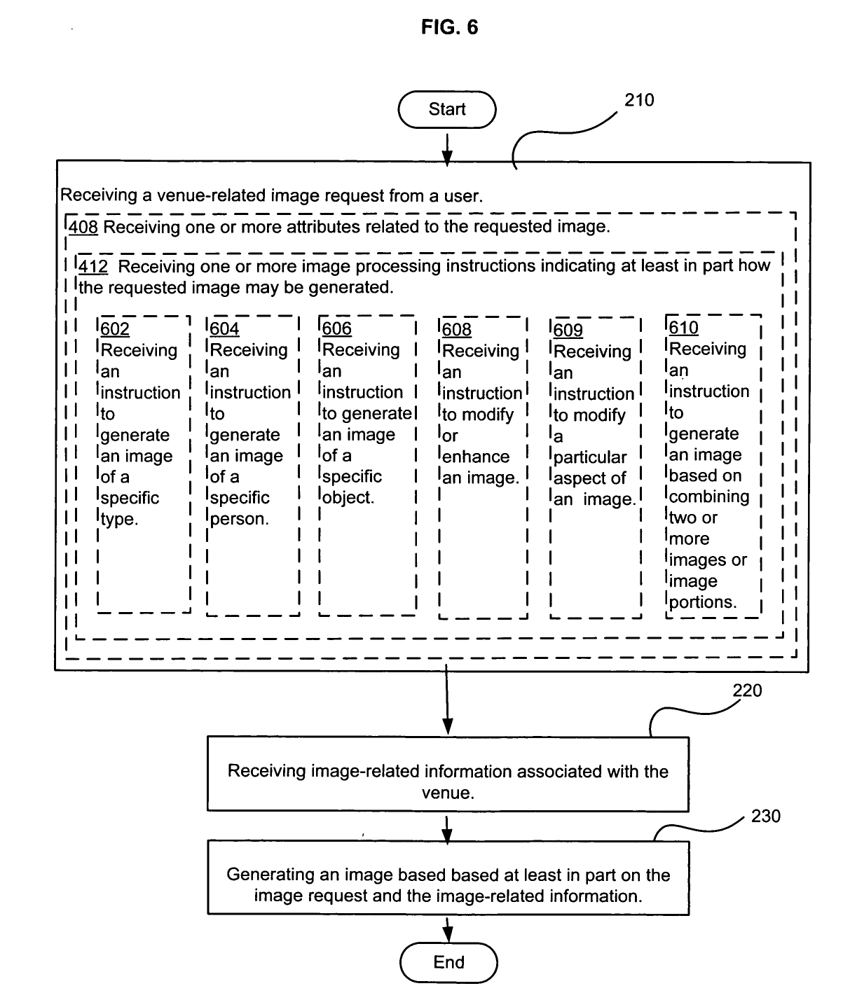

FIG. 6 illustrates an alternative embodiment of the example operational flow 200 of FIG. 2. FIG. 6 illustrates an embodiment where the receiving operation 210 may include at least one additional operation. Additional operations may include operations 602, 604, 606, 608, 609, and 610. Operations 408 and 412 were previously described with reference to FIG. 4. At receiving operation 602, an instruction to generate an image of a specific type may be received. For example, an instruction may be received to generate a close up image or to crop a portion of an image, etc. At receiving operation 604, an instruction may be received to generate an image of a specific person. At receiving operation 606, an instruction may be received to generate an image of a specific object.

At receiving operation 608, an instruction to modify or enhance an image may be received. For example, an instruction may be received to improve the clarity, lighting or focus of an image, etc. Or, in another example, an instruction may be received to enhance a first image based on information provided within a second image. For example, a first image of a performer on a stage or other venue may be captured by a user at the venue and provided as part of a venue-related image request (210, FIG. 2). A second image of the same performer may be captured by a third party (captured either at that performance or venue or another performance). The second image may be provided or received, for example, as image-related information associated with the venue (operation 230). This second image of the performer may be captured by other users at the venue (e.g., watching the performance) or by other image capture devices or cameras provided at or by the venue. The second image of the performer may be used to enhance or correct the original image of the performer provided in the user's image request.

At receiving operation 609, an instruction to modify a particular aspect of an image may be received. By way of example, the particular aspect to be modified may include contrast, focus, cropping of the image, resolution, color depth or pixel depth, scene composition, setting and/or other image-related aspects.

At receiving operation 610, an instruction to generate an image based on combining two or more images or portions of images may be received. For example, the instruction may indicate that a head from a first image and a body or background of a second image should be combined to generate the requested image.

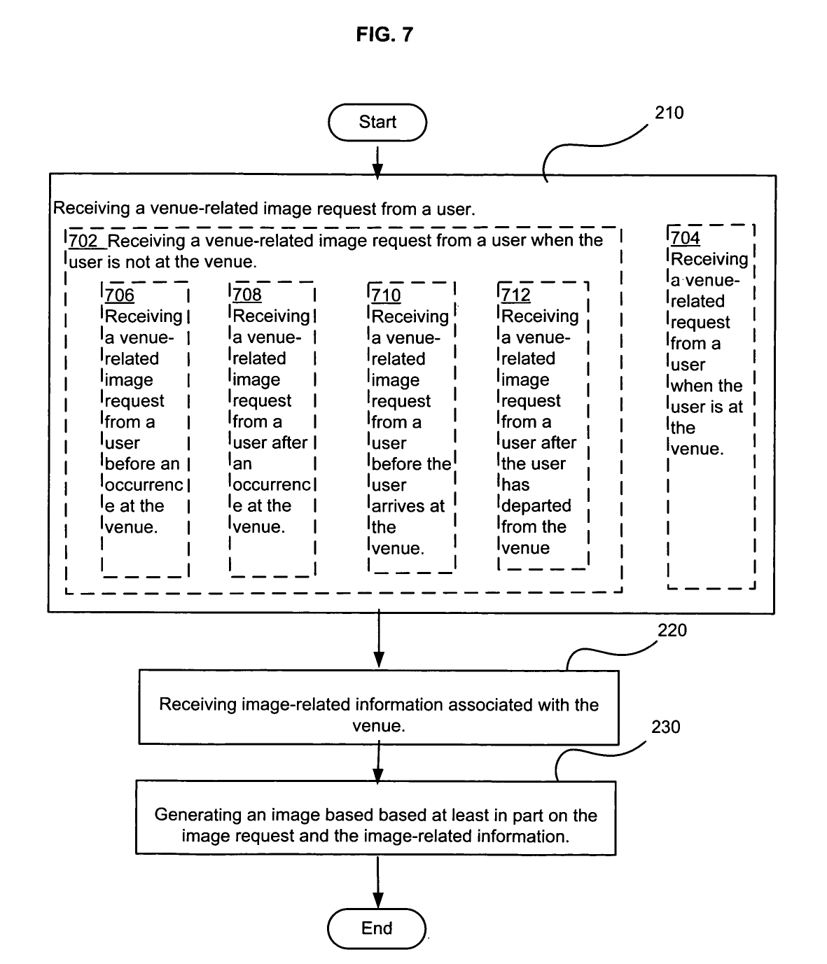

FIG. 7 illustrates an alternative embodiment of the example operational flow 200 of FIG. 2. FIG. 7 illustrates an embodiment where the receiving operation 210 may include at least one additional operation. Additional operations may include operations 702, 704, 706, 708, 710, and 712.

At receiving operation 702, a venue-related image request is received from a user when the user is not at the venue. For example, the user may have not yet arrived at the venue, or may have already departed from the venue (e.g., concert, ski slope, football game). At receiving operation 706, a venue-related image request is received from a user before an occurrence at the venue. For example, the image request from the user may be received before the football game, before halftime, before skiing that day, before skiing down a particular slope, before a concert, or before a particular song, etc. At receiving operation 708, a venue-related image request is received from a user after an occurrence at the venue. In an example embodiment, the image request may be received from a user after skiing for the day, after skiing down a particular slope, after a player scores a goal or a touchdown during a game, after the game is over etc. At receiving operation 710, a venue-related image request is received from a user before the user arrives at the venue (e.g., via web request or email or wireless communication). At receiving operation 712, a venue-related image request is received from a user after the user has departed from the venue.

At receiving operation 704, a venue-relate request is received from a user when (or while) the user is at the venue. For example, a request for an image of a performer may be received while the user is attending the concert or performance. In another example embodiment, an image request may be received from a user during a football game as a player scores a touchdown. To submit an image request, a user may actuate his image capture device or image request device while he is at the venue. In yet another example, a request for an image may be received from a user while he is skiing down a slope. For example, the user may click or actuate his image requesting device at the moment or about the moment or proximate to the moment that he does some action of which he would like to receive an image or photograph. The image may be generated, for example, based upon images or information provided by or at the venue or by other users at the venue.

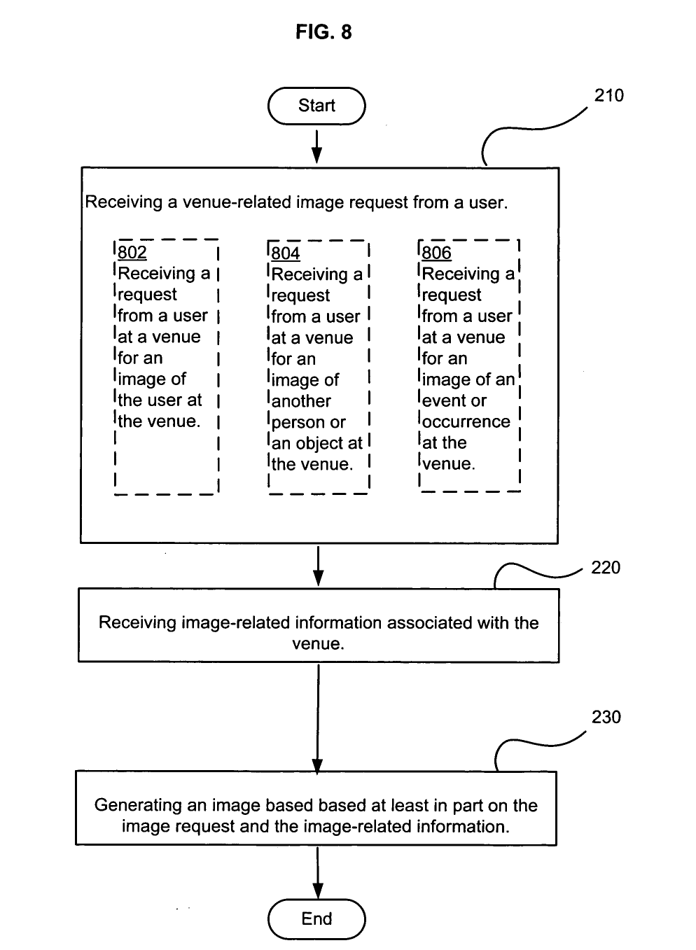

FIG. 8 illustrates an alternative embodiment of the example operational flow 200 of FIG. 2. FIG. 8 illustrates an embodiment where the receiving operation 210 may include at least one additional operation. Additional operations may include operations 802, 804, and 806. At receiving operation 802, a request may be received from a user at a venue for an image of the user at the venue. In an example embodiment, a user may be skiing down a ski slope. A request may be submitted by the user and received, requesting an image of the user as he skis down the slope, for example. At receiving operation 804, a request may be received from a user at a venue for an image of another person or an object at the venue. For example, a user may be attending a concert. A request may be received from the user while he is at the concert requesting an image of the performer on stage. Or in another example embodiment, the user may be attending a football game, and a request for an image may be received from the user requesting an image of a running back playing in the game (e.g., scoring a touchdown), or a request for an image of one of the cheerleaders or another spectator at the game. At receiving operation 806, a request may be received from a user at a venue for an image of an event or occurrence at the venue, such as an image of a touchdown being scored, an image of a performance, an image of fireworks, etc.

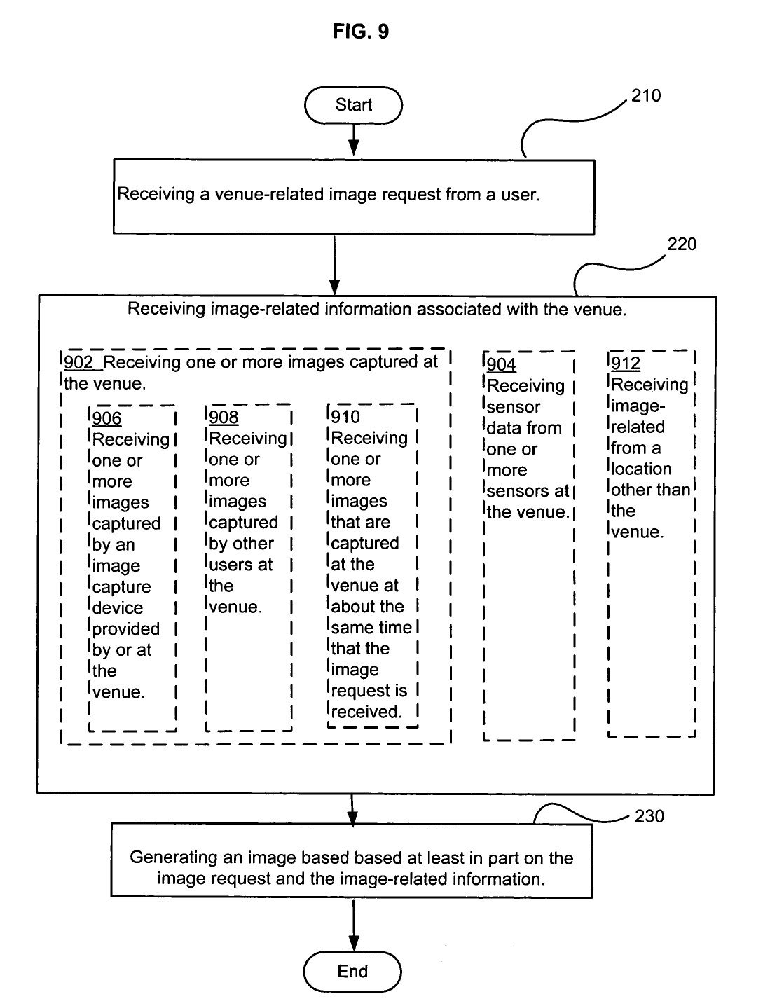

FIG. 9 illustrates an alternative embodiment of the example operational flow 200 of FIG. 2. FIG. 9 illustrates an embodiment where the receiving operation 220 may include at least one additional operation. Additional operations may include operations 902, 904, 906, 908, 910, and 912.

At receiving operation 902, one or more images captured at the venue may be received. These images may be, for example, images captured by other users or other spectators at a concert, images captured by other skiers on a ski slope, or images captured by image capture devices provided at or by the venue. For example, an image service may provide high quality cameras at the venue to capture images of the performers, which may then be made available for purchase or viewing by users, or may be used (e.g., as image-related information associated with the venue) to modify or enhance a user's own images or photographs captured at the venue. For example, a user may capture an image of a running back scoring a touchdown at a football game, but the image is unfocused or too far away. A request from the user may be received (including the image of the running back captured by the user) to enhance the focus of his image. The other image(s) captured at the game of the running back (e.g., as image-related information associated with the venue) may be used by the image service to improve the focus of the user's image, as requested. This is merely an example and the invention is not limited thereto.

At receiving operation 906, one or more images are received that are captured by an image capture device provided by or at the venue. For example, images may be received from venue-provided image capture devices, such as image capture devices provided at a concert or on a ski slope. At receiving operation 908, one or more images are received that are captured by other users at the venue. For example, images may be received from other spectators at a game or at a concert who have captured images of the performer or a player, for example.

At receiving operation 910, one or more images are received that have been captured at the venue at about the same time that the image request is received. For example, a request for an image of a performer may be received from a user who is attending the concert. In response to the image request, an image may be generated or obtained of the performer that was captured at about the same time the image request was received. This may allow a user to request an image in time proximity to his request. Alternatively, a user's image request may include a time or time stamp for the requested image, which would allow an image to be obtained or generated that was captured at about the same time. At receiving operation 912, image-related information (such as sensor data or images, image portions or other image-related information) may be received from a location other than the venue. For example, lighting queues associated with the venue may be received from a website or database, or images associated with the venue or an event or occurrence at the venue may be received from a website or database.

At receiving operation 904, sensor data is received from one or more sensors at the venue. Sensor data may include data relating to the lighting conditions at the venue or other image-related data. This data may be helpful in generating or enhancing images captured at the venue.

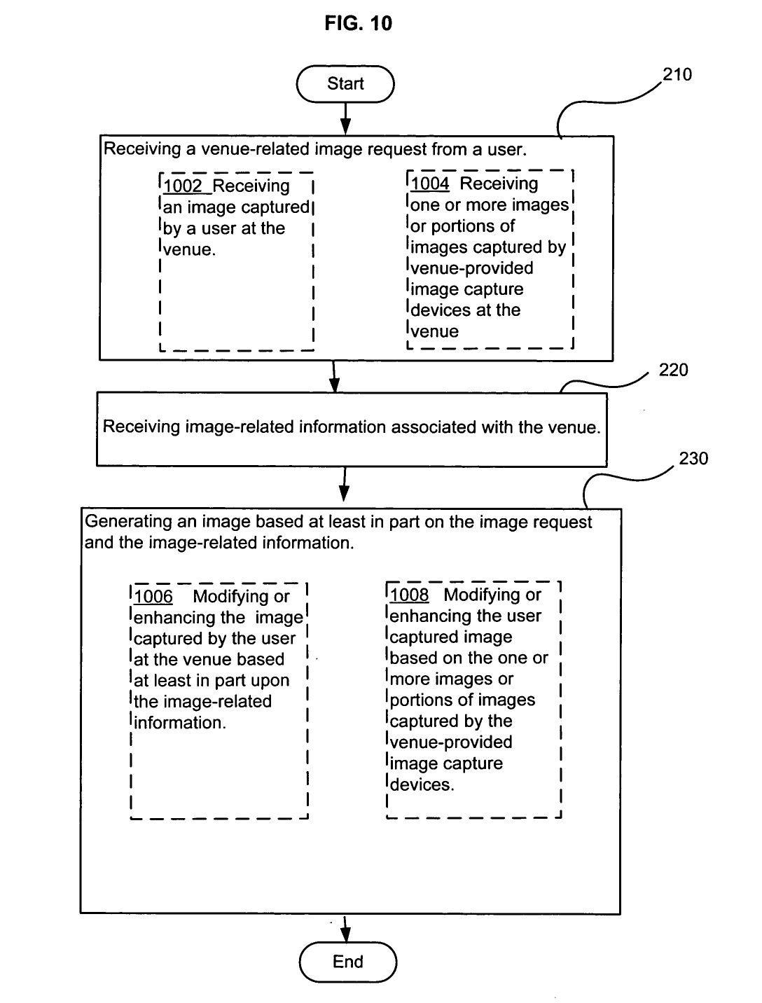

FIG. 10 illustrates an alternative embodiment of the example operational flow 200 of FIG. 2. FIG. 10 illustrates an embodiment where the receiving operation 210 and/or generating operation 230 may include at least one additional operation. Additional operations may include operations 1002, 1004, 1006 and 1008.

At receiving operation 1002, an image captured by the user at the venue is received. At generating operation 1006, the image captured by the user at the venue is modified or enhanced based at least in part upon the image-related information. For example, an image (e.g., provided in the image request) captured by a user at a football game of a player scoring may be enhanced (e.g., to improve focus or clarity) based on the image captured by the other user at the game.

At receiving operation 1004, one or more images or portions of images are received that have been captured by venue-provided image capture devices at the venue. At generating operation 1008, the user captured image is modified or enhanced based on the one or more images or portions of images captured by the venue-provided image capture devices.

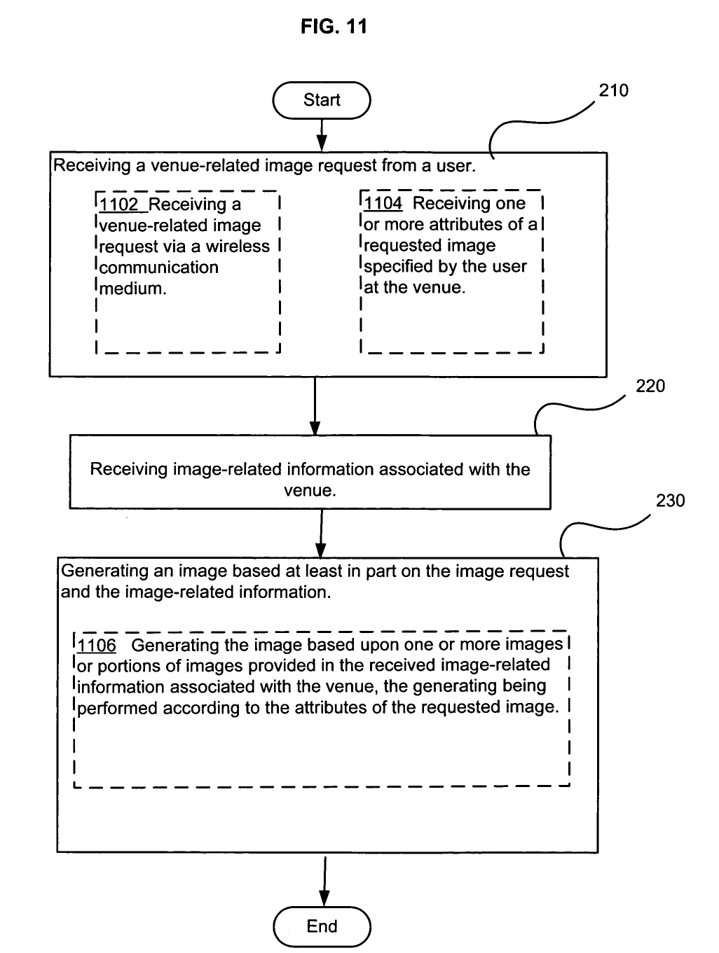

FIG. 11 illustrates an alternative embodiment of the example operational flow 200 of FIG. 2. FIG. 11 illustrates an embodiment where the receiving operation 210 and/or generating operation 230 may include at least one additional operation. Additional operations may include operations 1102, 1104 and 1106. At receiving operation 1102, a venue-related image request is received via wireless communication medium. The wireless communication medium may be a wireless LAN link or cellular link or other wireless medium.

At receiving operation 1104, one or more attributes of a requested image specified by the user at the venue are received. At generating operation 1106, an image is generated based upon one or more images or portions of images provided in the received image-related information associated with the venue, the generating being performed according to the attributes of the requested image.

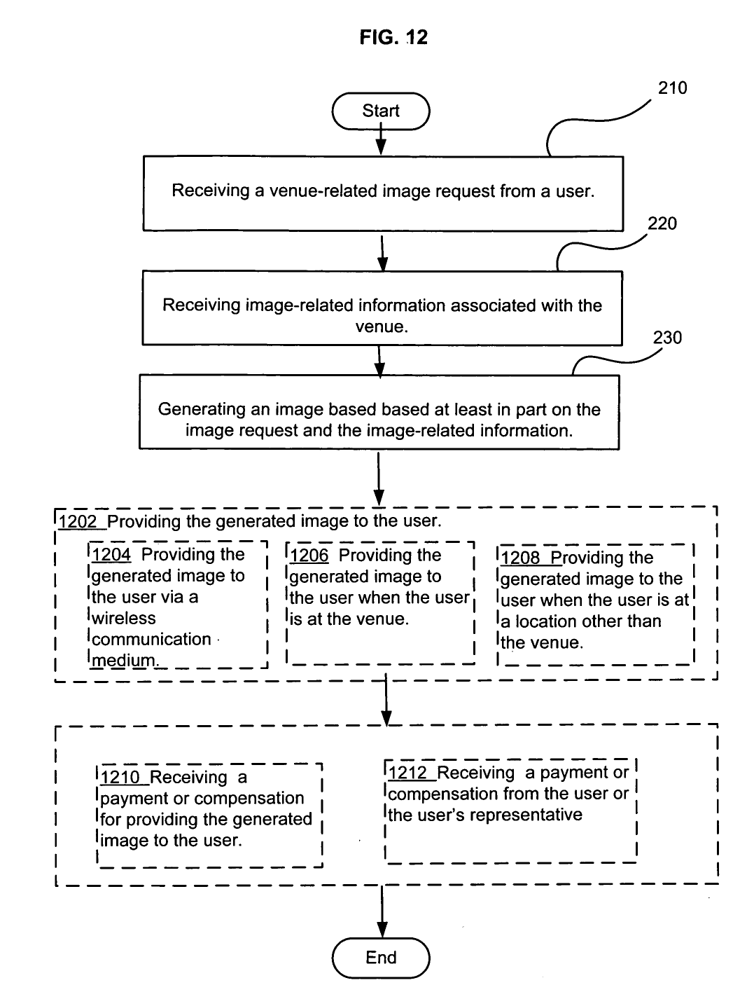

FIG. 12 illustrates an alternative embodiment of the example operational flow 200 of FIG. 2. FIG. 12 illustrates an embodiment where the operational flow 200 may include at least one additional operation. Additional operations may include operations 1202, 1204, 1206, 1208, 1210 and 1212.

At providing operation 1202, the generated image is provided to the user. At providing operation 1204, the generated image is provided to the user via a wireless communication medium.

At providing operation 1206, the generated image is provided to the user when the user is at the venue. For example, the requested image of the performer on stage is generated and then provided to the user while he is still attending the concert, or the image requested of the player scoring the touchdown is provided to the user while he is still at the football game, or the image requested of the skier as he skis down the slope is provided to the user as he skis on the slope (or while he is still at the ski resort).

At providing operation 1208, the generated image is provided to the user when (or while) the user is at a location other than the venue. For example, the requested image of the player scoring the touchdown or of the user skiing down the slope is provided to the user after he has left the game and ski resort, respectively.

At receiving operation 1210, a payment or compensation is received for providing the generated image to the user. At receiving operation 1212, a payment or compensation is received from the user or the user's representative. After receiving the requested image (or before or concurrent with submitting an image request), a payment from the user may be received via electronic transaction, such as a credit card transaction.

Payment may refer generally to any type of monetary compensation, and/or non-monetary compensation, and/or economic value exchange. Such payment may, for example, occur between any pair of entities and/or other group of entities. By way of example and not limitation, a payment may include a non-monetary payment, such as a credit or coupon that may be exchanged for goods or services, a reduced or eliminated cost to a consumer or user for related or non-related goods or services. In another example, a payment may include granting a party certain rights or permissions as payment, such as information-related permissions. This may involve granting a party rights to certain information the party ordinarily would not have rights to access, or the right to use certain information in a particular manner. For example, one type of payment may include a party allowing another party to keep a user's personal information in a database for marketing or research purposes. In another example, as compensation or payment, a consumer or user may grant another party the right to monitor a computer usage, or preferences or buying habits of the consumer in certain contexts, or the right to monitor a physical location or activity of the consumer. The consumer also may accept cash or cash-equivalents as payment from the provider for providing such entitlements, rights, or permissions. Thus, by providing and/or receiving monetary or non-monetary value, in an amount that may be designated as part of an agreement between the relevant parties, the parties may gain advantages and benefits that are mutually acceptable to both.

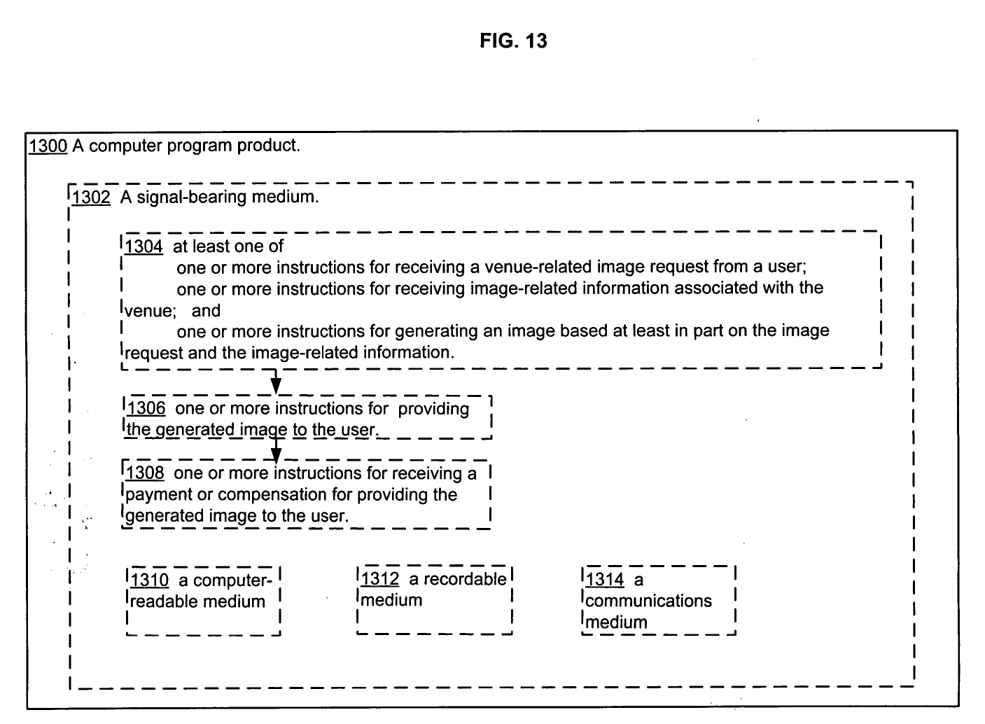

FIG. 13 illustrates a partial view of an example computer program product 1300 that may include a computer program 1304 for executing a computer process on a computing device. An embodiment of the example computer program product 1300 may be provided using a signal-bearing medium 1302, and may include at least one of one or more instructions for receiving a venue-related image request from a user, one or more instructions for receiving image-related information associated with the venue, and one or more instructions for generating an image based at least in part on the image request and the image-related information. In an alternative embodiment, the signal-bearing medium 1302 may include one or more additional instructions, such as instructions 1306 and/or 1308. The signal-bearing medium 1302 may include one or more instructions for providing the generated image to the user (1306), and/or one or more instructions for receiving a payment or compensation for providing the generated image to the user (1308). The one or more instructions may be, for example, computer executable and/or logic-implemented instructions. The signal-bearing medium 1302 may include one or more of a computer-readable medium 1310, a recordable medium 1312, or a communications medium 1314.

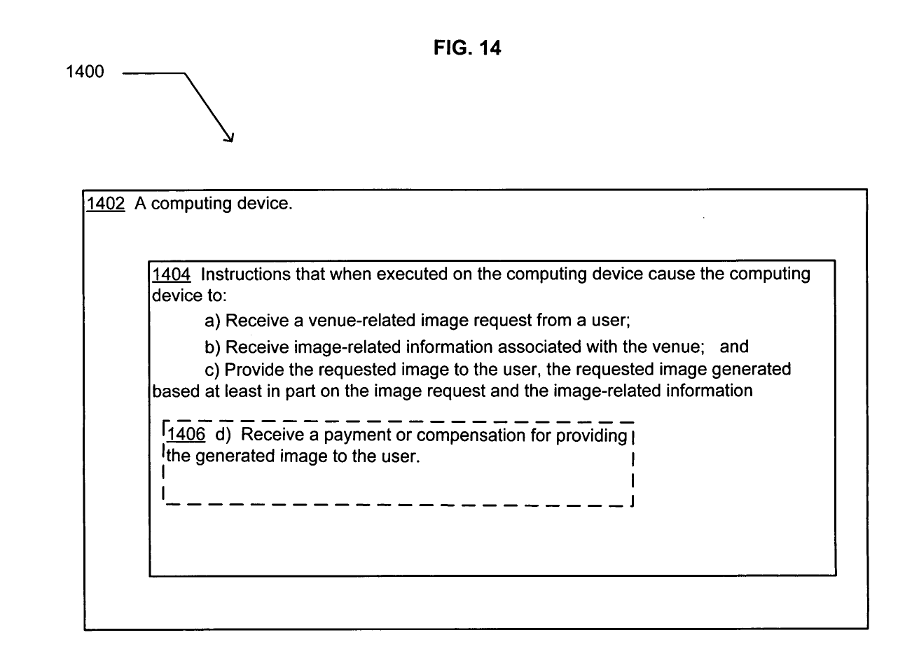

FIG. 14 illustrates an example apparatus in which embodiments may be implemented. The apparatus 1400 includes a computing device 1402. The computing device may include instructions 1404, that when executed on the computing device cause the computing device to receive a venue-related image request from a user, receive image-related information associated with the venue, and provide the requested image to the user, the requested image generated based at least in part on the image request and the image-related information. The instructions 1404 may include an additional instruction 1406. At receiving instruction 1406, the instruction will cause the computing device 1402 to receive a payment or compensation for providing the generated image to the user.

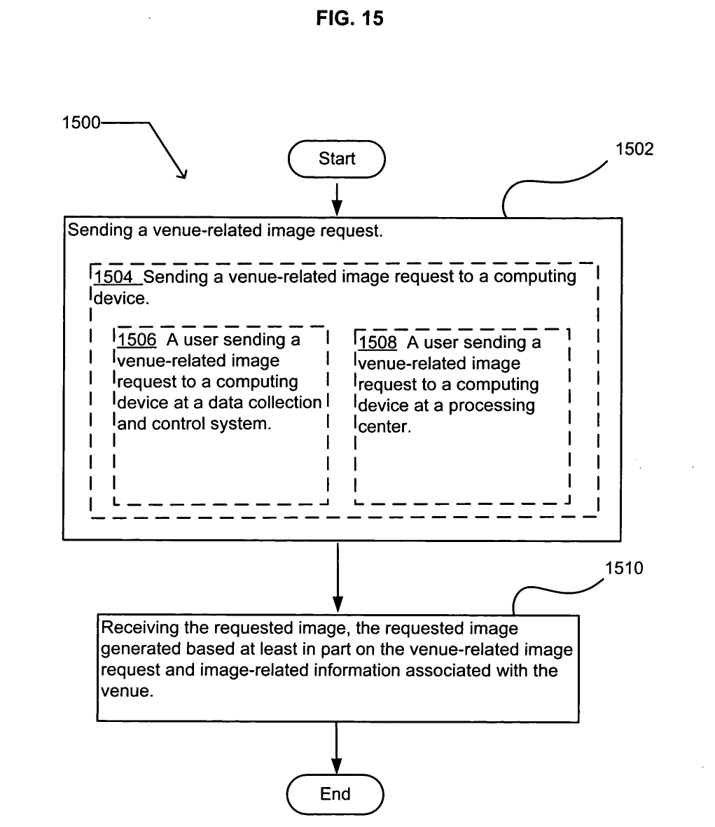

FIG. 15 illustrates an operational flow 1500 representing example operations to receive a requested image. After a start operation, the operational flow 1500 moves to a receiving operation 1502 where a user sends a venue-related image request. At receiving operation 1510, the requested image is received, the requested image generated based at least in part on the venue-related image request and image-related information associated with the venue. The operational flow 1500 then moves to an end operation.

As shown in FIG. 15, there are one or more additional operations which may be included in the sending operation 1502 of example operational flow 1500. The additional operations may include operations 1504, 1506 and 1508. At operation 1504, a venue-related image request is sent to a computing device. At operation 1506, a user sends a venue-related image request to a computing device at a data collection and control system. At operation 1508, a user sends a venue-related image request to a computing device at a processing center.

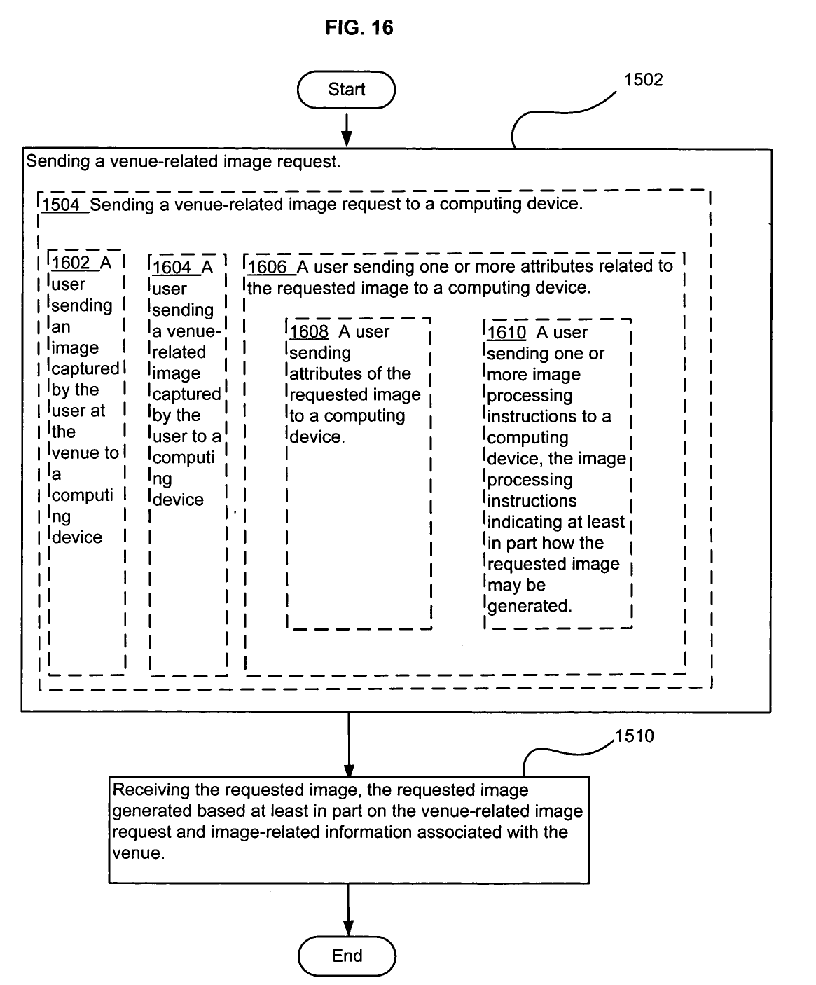

FIG. 16 illustrates an alternative embodiment of the example operational flow 1500 of FIG. 15. FIG. 16 illustrates an embodiment where the sending operation 1504 of operational flow 1500 may include at least one additional operation. Additional operations may include operations 1602, 1604, 1606, 1608 and 1610.

At sending operation 1602, a user sends an image captured by the user at the venue to a computing device. At sending operation 1604, a user sends a venue-related image captured by the user to a computing device. At sending operation 1606, a user sends one or more attributes related to the requested image to a computing device. At sending operation 1608, a user sends attributes of the requested image to a computing device. At sending operation 1610, a user sends one or more image processing instructions to a computing device, the image processing instructions indicating at least in part how the requested image may be generated.

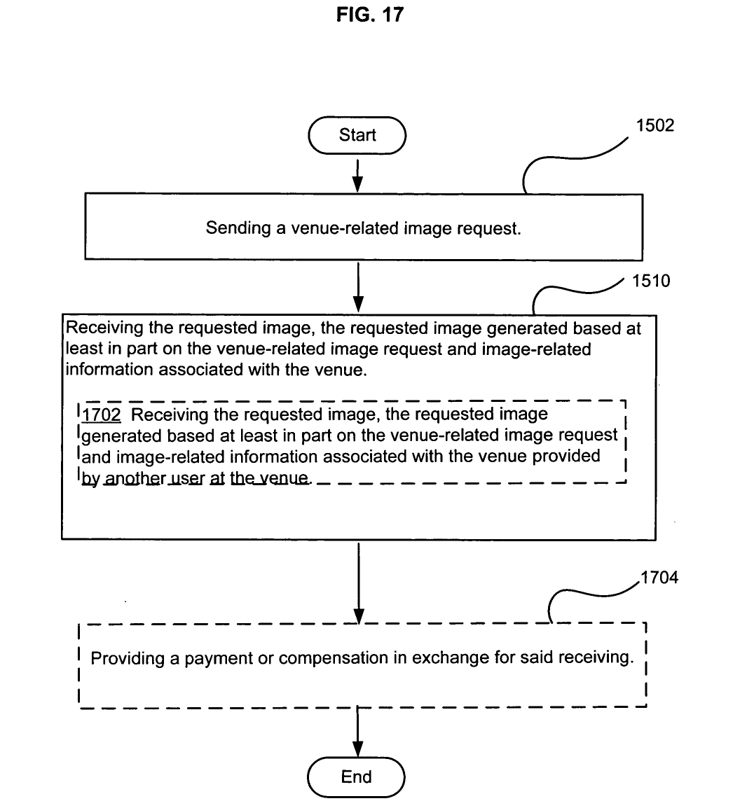

FIG. 17 illustrates an alternative embodiment of the example operational flow 1500 of FIG. 15. FIG. 17 illustrates an embodiment where the operational flow 1500 may include at least one additional operation, and/or the receiving operation 1510 may include an additional operation. Additional operations may include operations 1702 and 1704. At receiving operation 1702, the requested image is received, the requested image generated based at least in part on the venue-related image request and image-related information associated with the venue provided by another user at the venue. At providing operation 1704, a payment or compensation is provided in exchange for the receiving.

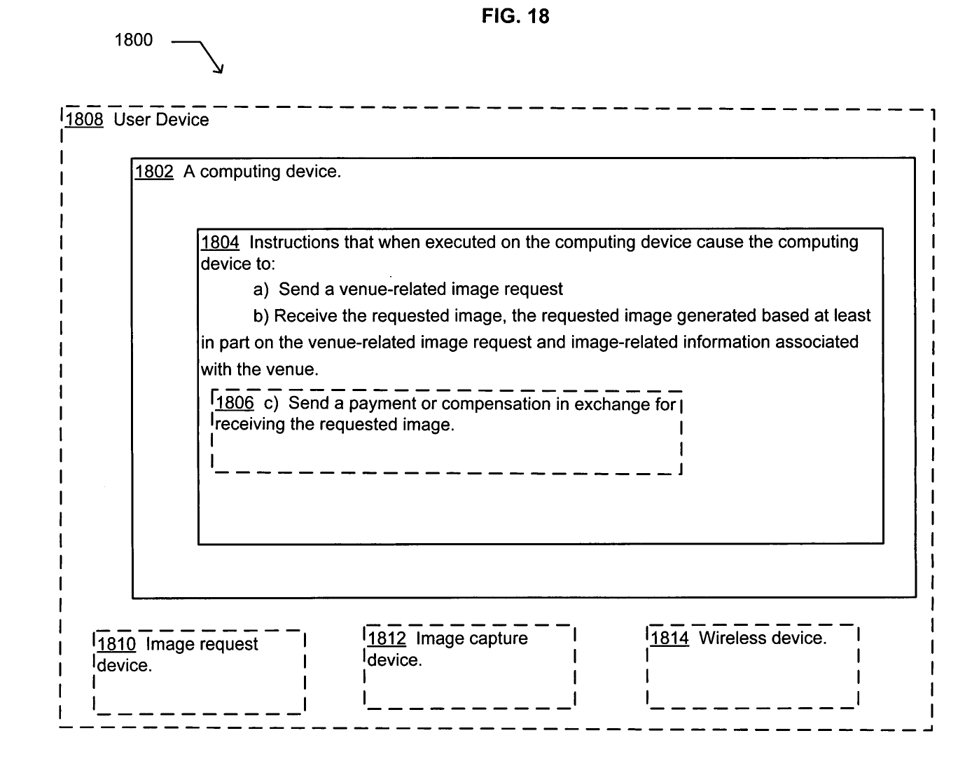

FIG. 18 illustrates an example apparatus 1800 in which embodiments may be implemented. The apparatus 1800 includes a computing device 1802. The computing device 1802 may include instructions 1804, that when executed on the computing device cause the computing device to send a venue-related image request, and receive the requested image, the requested image generated based at least in part on the venue-related image request and image-related information associated with the venue. In an example embodiment, the computing device 1802 may be included within a user device 1808, such as an image request device 1810, or an image capture device 1812, or a wireless device 1814 that may be used by a user to request an image and/or capture an image.

The instructions 1804 may include an additional instruction 1806. At send instruction 1806, a payment or compensation is sent (e.g., by the user) in exchange for receiving the requested image. For example, a user may send this payment to a computing device provided as part of a data collection and control system or a processing center (e.g., image processing center).

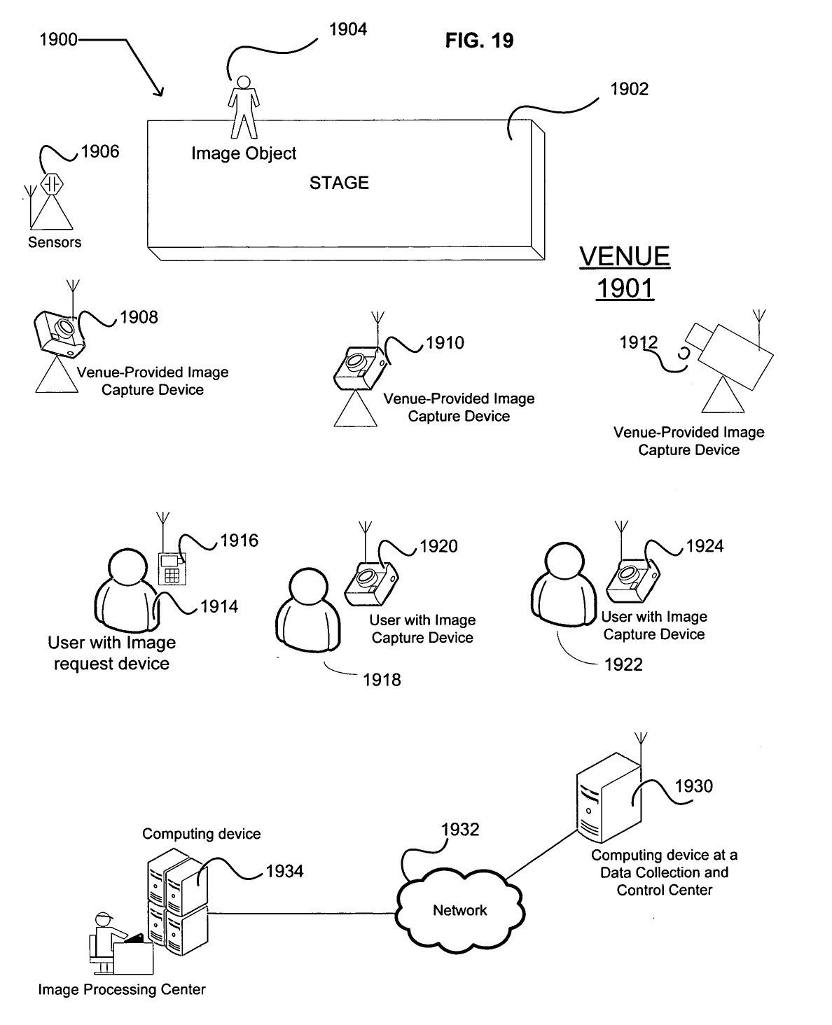

FIG. 19 is an example environment 1900 in which various embodiments may be used or implemented. Referring to the environment 1900 of FIG. 19, a venue 1901 is provided. In the example of FIG. 19, the venue 1901 may be a concert hall having a stage 1902 where a performer may be performing. The performer in this example is shown in FIG. 19 as image object 1904 since in this example it may be desirable for a user to obtain an image of the performer. One or more sensors 1906 may provide sensor data, such as light intensity near the stage 1902, and other image-related data that may be useful in capturing or processing images. A number of venue-provided image capture devices 1908, 1910 and 1912 may be provided around venue 1901 to capture images of the performer or image object 1904 and/or other objects or people.

A number of users or spectators may be present at venue 1901 as well. For example, user 1914 may operate an image request device 1916. Image request device 1916 may be, for example, an electronic device that allows a user to input information describing a requested image. For example, the image request device may be a PDA, cell phone, or other wireless handheld device that may display or identify available images recently taken at the venue and allow a user to request the image. Or, the image request device 1916 may allow a user to input or select one or more attributes describing the requested image.

Image request device 1916 may or may not be able to capture an image as well. In one example embodiment, image request device 1916 may be capable of submitting or transmitting an image request and may not have the ability to capture and send images. In a second example embodiment, image request device 1916 may comprise an image capture device such as a camera or cell phone with camera, or other electronic device with the ability to capture images or take pictures. In this second example embodiment, a user may be able to submit a request for an image that includes a captured image. The image request may be, for example, a venue-related image request, such as a request for an image of an object or person, etc. at a particular venue, although the invention is not limited thereto. In another example embodiment, a venue-related image request may include a request for an image of a person, object or something at the venue where the user is located, although the invention is not limited thereto. In yet another embodiment, the venue-related image request may be a request for an image related to some aspect of the venue (e.g., a request for an image of a person or object at the venue, or for an image of something that occurred at the venue, for an image of an aspect of the venue, or of an image that is otherwise related to the venue).

A user 1918 may operate an image capture device 1920, while a user 1922 may operate an image capture device 1924. These users 1918 and 1922 may capture images of the performer or image object 1904 at venue 1901 during the performance, for example. Likewise, the venue-provided image capture devices may also capture images of the performer or an image object at the venue, e.g., during the performance.

Referring to FIG. 19 again, a computing device 1930 may be provided at a data collection and control center, which may be located at the venue or some other location. In an example embodiment, computing device 1930 may communicate with sensors 1906 and devices 1908, 1910, 1912, 1916, 1920 and 1924 via a communication medium such as a wireless link, for example. In an example embodiment, computing device 1930 may control or coordinate venue-provided image capture devices 1908, 1910 and 1912 to control the capture of images at the venue. This control may be performed in real-time based upon image requests received from a user at this venue, or the control may be performed based upon instructions provided prior to the performance, e.g., based on historical image requests for images for other venues or on image requests received prior to the performance.

In an example embodiment, computing device 1930 may receive an image request from user 1914 via image request device 1916. The image request may or may not include an image captured by device 1916. Computing device 1930 may also receive various image-related information, such as, for example, sensor data from sensors 1906 and images captured by one or more of devices 1908, 1910, 1912, 1920 and 1924, although the invention is not limited thereto. Computing device 1930 may provide the image request and the image-related information to a computing device 1934 via a network 1932, for example. In an example embodiment, computing device 1934 may be provided at an image processing center and may assist in providing image processing services pursuant to received image requests.

In FIG. 19, computing device 1934 at the image processing center may generate the requested image based upon the image request and image-related information, for example. In an example embodiment, the generated image may be sent back to computing device 1930 where the generated image may be communicated, e.g., via wireless link, to the requesting user device 1916 while the user is still at the venue or after the user has left the venue. Alternatively, the requested images may be uploaded by device 1930 or 1934 to a database or website and made available to the user or emailed to the user, etc.

The user 1914 or user device 1916 may also provide a payment or compensation to the image processing center, such as through a credit card or other financial transaction via a communication with computing device 1930 and/or computing device 1934. Likewise, other users at the venue 1901 (e.g., users 1918, 1922) may capture images and provide these images to computing device 1930, and may receive payment for such images, such as for example, when the image is provided or used in the generation of an image that is provided to the user 1914 upon request.

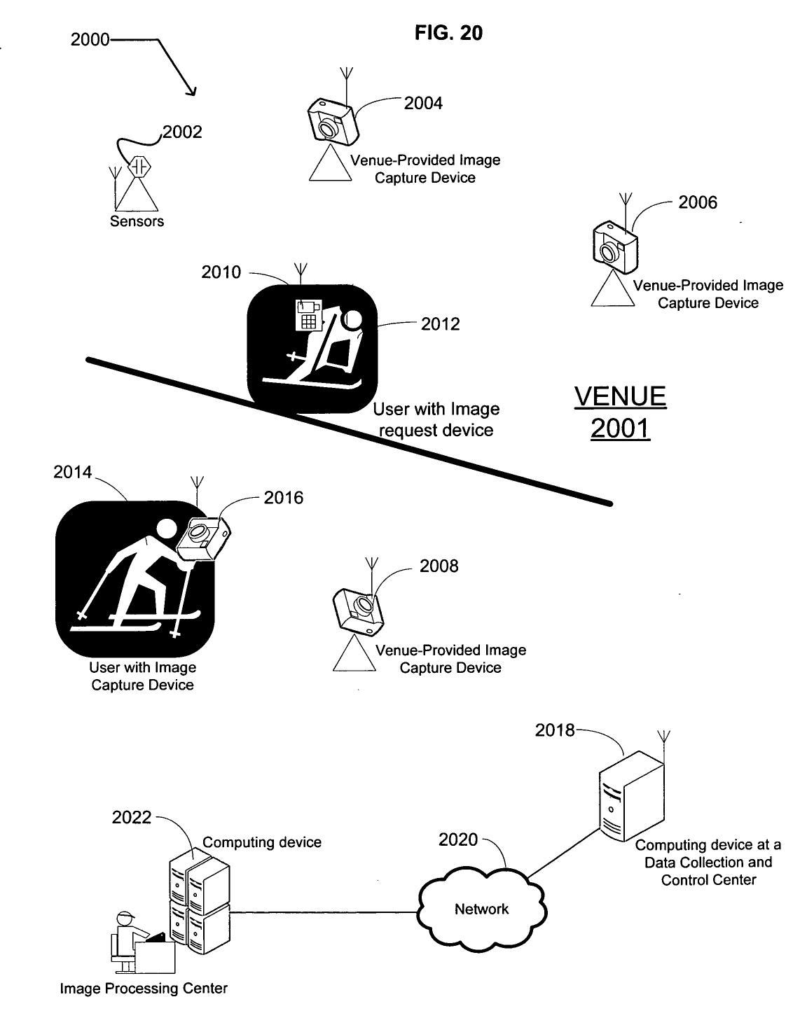

FIG. 20 is an example environment 2000 in which various embodiments may be used or implemented. Referring to the environment 2000 of FIG. 20, a venue 2001 is provided. In the example of FIG. 20, the venue 2001 may be a mountain at a ski resort where a user 2010 may be skiing down the mountain. One or more sensors 2002 may provide sensor data, such as light intensity near the ski slope and other image-related data that may be useful in capturing or processing images. A number of venue-provided image capture devices 2004, 2006 and 2008 may be provided around venue 2001 to capture images around the venue 2001, such as objects of skiers or objects. Also, another user (skier) 2014 may be skiing on the mountain and may be operating an image capture device 2016.

User 2012 may be operating an image request device 2010. User 2012 may indicate, either before, during or after skiing, that he would like pictures or images of himself while skiing, and may specify attributes of the requested images. The various image capture devices at venue 2001 may capture images of the user 2012 while he is at venue 2001 (e.g., while he skis down the mountain). In an example embodiment, user 2012 may include a user identification to identify the user, such as a RFID transmitter to transmit a unique RFID signal, or a physical indicia such as a number placed on the user's jacket or a hat of a specific color, etc.

In FIG. 20, the images captured by the various image capture devices may be provided via a communication medium (e.g., wireless link) to a computing device 2018 at a data collection and control center. In an example embodiment, computing device 2018 may wirelessly control various venue-provided image capture devices to seek out and capture images of user 2012, e.g., based on the RFID signal or other user identification associated with the user 2012.

For example, user 2012 may be skiing down the mountain and may use his image request device 2010 to submit a request to computing device 2018 for an image of the user at a particular point on the mountain, e.g., “capture image of me right here, right now.” Also, various image-related information, such as data from sensors 2002 and images from image capture devices 2004, 2006, 2008, 2016, etc. may be sent to computing device 2018. The image request and the image-related information may be sent to a computing device 2022 at an image processing center via a network 2020. Computing device 2022 may generate (or obtain) the requested image, such as by processing an image included in the image request to enhance or modify the image, or by obtaining an image of the user 2012 captured by one of the image capture devices at the venue pursuant to the image request, for example. For example, images of the user 2012 may be identified by device 2018 or device 2022 based on a user identification associated with the user (e.g., RFID or physical indicia). The generated or requested image may then be returned to the user 2012 or made available to the user via a database or website, etc.

While certain features of the described implementations have been illustrated as disclosed herein, many modifications, substitutions, changes and equivalents will now occur to those skilled in the art. It is, therefore, to be understood that the appended claims are intended to cover all such modifications and changes as fall within the true spirit of the embodiments of the invention.

While particular aspects of the present subject matter described herein have been shown and described, it will be apparent to those skilled in the art that, based upon the teachings herein, changes and modifications may be made without departing from this subject matter described herein and its broader aspects and, therefore, the appended claims are to encompass within their scope all such changes and modifications as are within the true spirit and scope of this subject matter described herein. Furthermore, it is to be understood that the invention is solely defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” the term “comprising” should be interpreted as “including but not limited to,” etc.).

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.).

What is claimed is:

1. A method comprising:
receiving a venue-related image request from a user;
receiving image-related information associated with the venue; and
generating an image based at least in part on the image request and the image-related information.

2. The method of claim 1 wherein said receiving a venue-related image request comprises:
receiving a user identification.

3. The method of claim 2 wherein said receiving a user identification comprises:
receiving a radio frequency identification (RFID) associated with the user.

4. The method of claim 2 wherein said receiving a user identification comprises:
receiving information identifying a physical indicia associated with the user.

5. The method of claim 1 wherein said receiving a venue-related image request comprises:
at least one of
receiving a venue-related image request from a user's device,
receiving an image captured by the user at the venue,
receiving a venue-related image captured by the user, or
receiving one or more attributes related to the requested image.

6. The method of claim 5 wherein said receiving one or more attributes comprises:
at least one of
receiving attributes of the requested image, or
receiving one or more image processing instructions indicating at least in part how the requested image may be generated.

7. The method of claim 6 wherein said receiving attributes of the requested image comprises:
at least one of
receiving an attribute describing a time,
receiving an attribute describing a time of the image request,
receiving an attribute describing a location of a user,
receiving an attribute describing a location of a user's device,
receiving an attribute describing an object,
receiving an attribute describing a location of an object,
receiving an attribute describing a venue,
receiving an attribute describing a location within a venue,
receiving an attribute describing a type of image,
receiving an attribute describing a person,
receiving an attribute describing a group of people,
receiving an attribute describing a specific person from whom at least some of the image-related information may be received, or
receiving an attribute describing a group of people from whom at least some of the image-related information may be received.

8. The method of claim 6 wherein said receiving one or more image processing instructions comprises:
at least one of
receiving an instruction to generate an image of a specific type,
receiving an instruction to generate an image of a specific person,
receiving an instruction to generate an image of a specific object,
receiving an instruction to modify or enhance an image,
receiving an instruction to modify a particular aspect of an image, or
receiving an instruction to generate an image based on combining two or more images or image portions.

9. The method of claim 1 wherein said receiving a venue-related image request comprises:
at least one of
receiving a venue-related image request from a user when the user is not at the venue, or
receiving a venue-related image request from a user when the user is at the venue.

10. The method of claim 9 wherein said receiving a venue-related image request from a user when the user is not at the venue comprises:
at least one of
receiving a venue-related image request from a user before an occurrence at the venue, or
receiving a venue-related image request from a user after an occurrence at the venue.

11. The method of claim 9 wherein said receiving a venue-related image request from a user when the user is not at the venue comprises:
at least one of
receiving a venue-related image request from a user before the user arrives at the venue,
receiving a venue-related image request from a user after the user has departed from the venue.

12. The method of claim 1 wherein said receiving a venue-related image request comprises:
at least one of
receiving a request from a user at a venue for an image of the user at the venue,
receiving a request from a user at a venue for an image of an event or occurrence at the venue, or
receiving a request from a user at a venue for an image of another person or an object at the venue.

13. The method of claim 1 wherein said receiving image-related information associated with the venue comprises:
at least one of
receiving one or more images captured at the venue,
receiving sensor data from one or more sensors at the venue, or
receiving image-related information from a location other than the venue.

14. The method of claim 13 wherein said receiving one or more images captured at the venue comprises:
at least one of
receiving one or more images captured by an image capture device provided by or at the venue, or
receiving one or more images captured by other users at the venue.

15. The method of claim 13 wherein said receiving one or more images captured at the venue comprises:
receiving one or more images that are captured at the venue at about the same time that the image request is received.

16. The method of claim 1 wherein the receiving a venue-related image request comprises:
receiving an image captured by a user at the venue; and
wherein said generating comprises modifying or enhancing the image captured by the user at the venue based at least in part upon the image-related information.

17. The method of claim 16 wherein said receiving the image-related information comprises:
receiving one or more images or portions of images captured by venue-provided image capture devices at the venue; and
wherein said generating comprises modifying or enhancing the user captured image based on the one or more images or portions of images captured by the venue-provided image capture devices.

18. The method of claim 1 wherein said receiving a venue-related image request comprises:
receiving one or more attributes of a requested image specified by the user at the venue; and
wherein said generating comprises generating the image based upon one or more images or portions of images provided in the received image-related information associated with the venue, the generating being performed according to the attributes of the requested image.

19. The method of claim 1 wherein said receiving a venue-related image request comprises:
receiving a venue-related image request via a wireless communication medium.

20. The method of claim 1 and further comprising:
providing the generated image to the user.

21. The method of claim 20 wherein said providing comprises:
providing the generated image to the user via a wireless communication medium.

22. The method of claim 20 wherein said providing comprises:
providing the generated image to the user when the user is at the venue.

23. The method of claim 20 wherein said providing comprises:
providing the generated image to the user when the user is at a location other than the venue.

24. The method of claim 20 and further comprising:
receiving a payment or compensation for providing the generated image to the user.

25. The method of claim 20 and further comprising:
receiving a payment or compensation from the user or the user's payment representative.

26. A computer program product comprising:
a signal-bearing medium bearing at least one of
one or more instructions for receiving a venue-related image request from a user,
one or more instructions for receiving image-related information associated with the venue, and
one or more instructions for generating an image based at least in part on the image request and the image-related information.

27. The computer program product of claim 26, the signal-bearing medium further bearing one or more instructions for providing the generated image to the user.

28. The computer program product of claim 25, the signal-bearing medium further bearing one or more instructions for receiving a payment or compensation for providing the generated image to the user.

29. The computer program product of claim 26, wherein the computer program product includes a recordable medium.

30. An apparatus comprising:
a computing device; and
instructions that when executed on the computing device cause the computing device to
receive a venue-related image request from a user,
receive image-related information associated with the venue, and
provide the requested image to the user, the requested image generated based at least in part on the image request and the image-related information.

31. The apparatus of claim 30, wherein the instructions when executed on the computing device further cause the computing device to:
receive a payment or compensation for providing the generated image to the user.

32. A method comprising:
sending a venue-related image request; and
receiving the requested image, the requested image generated based at least in part on the venue-related image request and image-related information associated with the venue.

33. The method of claim 32 wherein said sending comprises:
sending a venue-related image request to a computing device.

34. The method of claim 33 wherein said sending comprises:
at least one of
a user sending a venue-related image request to a computing device at a data collection system, or
a user sending a venue-related image request to a computing device at a processing center.

35. The method of claim 33 wherein said sending a venue-related image request comprises:
at least one of
a user sending an image captured by the user at the venue to a computing device,
a user sending a venue-related image captured by the user to a computing device, or
a user sending one or more attributes related to the requested image to a computing device.

36. The method of claim 35 wherein said sending one or more attributes comprises:
at least one of
a user sending attributes of the requested image to a computing device, or
a user sending one or more image processing instructions to a computing device, the image processing instructions indicating at least in part how the requested image may be generated.

37. The method of claim 32 and further comprising:
providing a payment or compensation in exchange for said receiving.

38. The method of claim 32 wherein said receiving comprises:
receiving the requested image, the requested image generated based at least in part on the venue-related image request and image-related information associated with the venue provided by another user at the venue, the method further comprising providing a payment or compensation to the other user.

39. An apparatus comprising:
a computing device; and
instructions that when executed on the computing device cause the computing device to
send a venue-related image request, and
receive the requested image, the requested image generated based at least in part on the venue-related image request and image-related information associated with the venue.

40. The apparatus of claim 39, wherein the instructions when executed on the computing device further cause the computing device to:
send a payment or compensation in exchange for receiving the requested image.

41. The apparatus of claim 38, wherein the apparatus comprises:
a user device.

42. The apparatus of claim 41, wherein the user device comprises:
at least one of
an image request device,
an image capture device, or
a wireless device.
